(19) United States
(12) Patent Application Publication
(10) Pub. No.: US 2006/0283023 A1
(43) Pub. Date: Dec. 21, 2006

(54) Cutting apparatus

(76) Inventor: Scott L. Hesson, Richmond, IN (US)

Correspondence Address: BARNES & THORNBURG LLP, 11 SOUTH MERIDIAN, INDIANAPOLIS, IN, 46204, US

(21) Appl. No.: 11/157,581

(22) Filed: Jun. 21, 2005

(51) Int. Cl. B26B 27/00

(52) U.S. Cl. 30/296.1

(57) ABSTRACT

A cutting apparatus includes a chain saw, a power source to operate the chain saw, and a pole. The chain saw and the power source are coupled to the pole to be carried thereby to facilitate use of the chain saw to cut vegetation and other objects.

### BACKGROUND

The present disclosure relates to cutting apparatus. More particularly, the present disclosure relates to chain saws. Chain saws may be used to cut a variety of objects including trees, branches, brush, and other vegetation.

### SUMMARY

According to the present disclosure, a cutting apparatus includes a chain saw and an elongated frame. The chain saw defines a saw plane to cut an object such as vegetation along the saw plane. The elongated frame is coupled to the chain saw to carry the chain saw. The elongated frame has a longitudinal axis which extends in non-parallel relation to the saw plane to facilitate cutting of the object at a relatively low level such as adjacent to a ground surface in the case of cutting vegetation.

Illustratively, the elongated frame includes a curved pole which defines the longitudinal axis of the frame. The chain saw is coupled to a first end portion of the pole. A power source is coupled to an opposite second end portion of the pole. A flexible drive shaft extends through the pole to connect the power source and the chain saw.

The pole is curved along its length at a bend between a longer portion of the pole and a shorter portion of the pole. The shorter portion includes the first end portion to which the chain saw is coupled and the longer portion includes the second end portion to which the power source is coupled. A handle and a shoulder harness for use by a person operating the cutting apparatus are coupled to the longer portion. The bend in the pole orients the saw plane of the chain saw to promote cutting of the object at the relatively low level.

Additional features of the disclosure will become apparent to those skilled in the art upon consideration of the following detailed description of illustrative embodiments exemplifying the best mode of carrying out the disclosure as presently perceived.

### BRIEF DESCRIPTION OF THE DRAWINGS

The detailed description particularly refers to the following figures in which:

FIG. 1 is a perspective view showing use of a cutting apparatus in accordance with the present disclosure to cut a small tree generally flush to a ground surface;

FIG. 2 is a side elevation view of the cutting apparatus showing a curved pole of the cutting apparatus extending between a chain saw coupled to a lower, first end portion of the pole and a power source coupled to an upper, second end portion of the pole and showing a longitudinal axis of the pole inclined relative to a horizontal saw plane defined by the chain saw such that the longitudinal axis is non-parallel to the saw plane;

FIG. 3 is an enlarged side elevation view of the chain saw of FIGS. 1 and 2, the chain saw including a guide bar on which a cutting chain is mounted and that defines the saw plane and includes a gear head about which a head guard extends;

FIG. 4 is a sectional view taken along lines 4-4 of FIG. 1 showing coupling of the head guard to the gear head;

FIG. 5 is a perspective view of the head guard;

FIG. 6 is an end elevation view of the head guard;

FIG. 7 is a plan view of the head guard; and

FIG. 8 is a bottom view of the head guard.

### DETAILED DESCRIPTION

A cutting apparatus 10 is configured for cutting an object 11 such as vegetation (e.g., trees, saplings, brush, branches, bushes) at a relatively low level adjacent to a ground surface 13, as shown, for example, in FIG. 1. Cutting apparatus 10 is portable and includes a chain saw 12 and an elongated frame 19 coupled to chain saw 12 to carry and maneuver chain saw 12. Chain saw 12 defines a saw plane 17 and is adapted to cut object 11 along saw plane 17. Frame 19 has a longitudinal axis 21 which extends in non-parallel relation to saw plane 17. Such an arrangement facilitates use of cutting apparatus 10 by a person 23 to cut object 11 at the relatively low level.

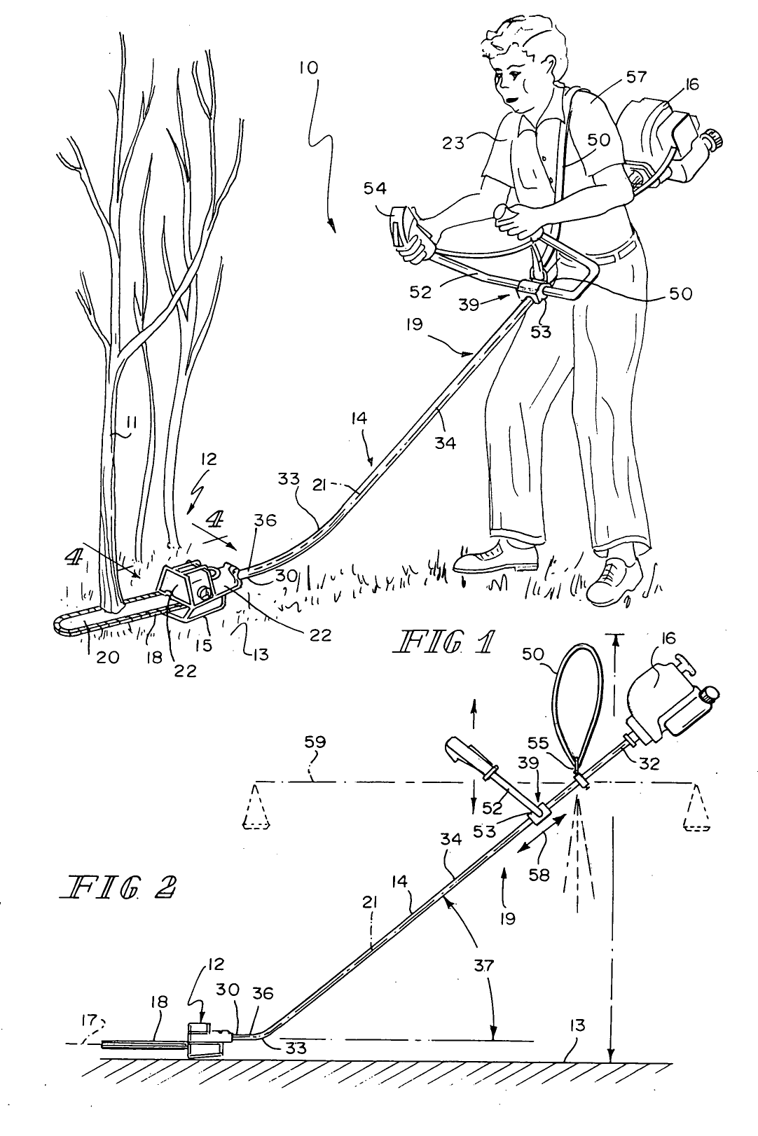

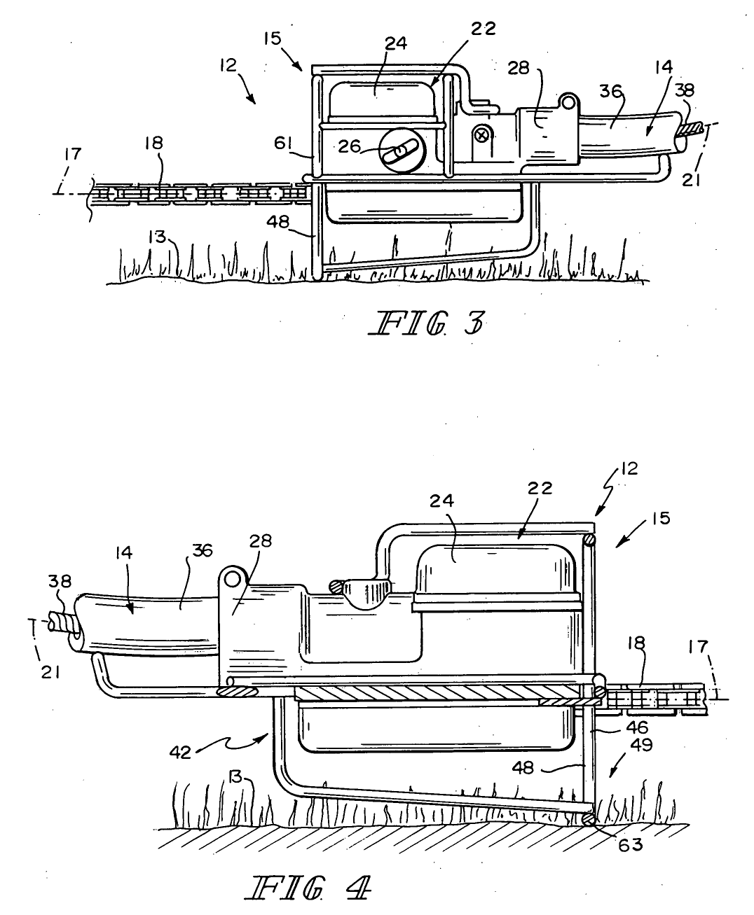

Frame 19 includes a pole 14, as shown, for example, in FIGS. 1 and 2. Pole 14 defines longitudinal axis 21 and includes a first end portion 30 and a second end portion 32. Chain saw 12 is coupled to first end portion 30. A power source 16 (e.g., an internal combustion engine or an electric motor) for operating chain saw 12 is coupled to second end portion 32. A flexible drive shaft 38 shown, for example, in FIGS. 3 and 4 connects power source 16 and chain saw 12 to transmit power from power source 16 to chain saw 12. Pole 14 is tubular so as to be formed to include a hollow region through which drive shaft 38 extends. Pole 14 thus provides means for carrying chain saw 12 and power source 16 in spaced-apart relation to one another to position chain saw 12 lower than power source 16 and adjacent to underlying ground surface 13 to cut vegetation or other objects.

Pole 14 includes a longer portion 34, a shorter portion 36 shorter than longer portion 34, and a bend 33, as shown, for example, in FIG. 2. Shorter portion 36 includes first end portion 30. Longer portion 34 includes second end portion 32. Bend 33 connects shorter and longer portions 34, 36 so that pole 14 is curved along its length as it extends longitudinally from first end portion 30 to second end portion 32. As such, longitudinal axis 21 extends at an angle 37 (e.g., about 45°) relative to saw plane 17 as axis 21 extends through longer portion 34. In this way, a person interface region 39 of apparatus 10 can be elevated relative to chain saw 12 to facilitate cutting object 11 at the relatively low level.

Person interface region 39 includes a pair of handles 52, as shown, for example, in FIGS. 1 and 2. Handles 52 are included in frame 19 and are coupled to longer portion 34 by use of a handle attachment 53. Illustratively, each handle 52 is configured as a bull-horn handle bar adapted to be gripped by the hand of person 23. A power-source controller 54 is coupled to one of handles 52 to allow person 23 to modulate the power produced by power source 16 and thus the operational speed of chain saw 12. Handle attachment 53 is configured to lock handles 52 in place at a selected position along longer portion 34. Handle attachment 53 is also configured for movement of handles 52 along axis 21 toward and away from power source 16 as indicated by double-headed arrow 58 to accommodate operators of different sizes.

Person interface region 39 further includes a shoulder harness 50 coupled to longer portion 34, as shown, for example, in FIGS. 1 and 2. Illustratively, shoulder harness 50 includes a single strap to wrap over a shoulder 57 of person 23. Harness 50 is coupled to longer portion 34 at a pivot point 55 to facilitate balancing of the weight of cutting apparatus 10 for ease of operation, as suggested by a phantom “balanced-weight” scale 59 in FIG. 2. Pivot point 55 is arranged between harness 50 and pole 14 to allow person 23 to swing cutting apparatus 10 back and forth along an arc in an oscillatory manner.

Shoulder harness 50 is arranged to provide means for maintaining separation between chain saw 12 and person 23 using chain saw 12. Shoulder harness 50 is coupled to longer portion 34 and keeps chain saw 12 separated from person 23 to inhibit contact between person 23 and chain saw 12.

Chain saw 12 includes a guide bar 20 and a chain 18 extending about a periphery of guide bar 20 for movement thereon, as shown for example, in FIGS. 1-4. Guide bar 20 is generally planar so as to define saw plane 17.

Chain saw 12 includes a gear head 22, as shown in FIGS. 3 and 4. Gear head 22 includes a housing 24 from which chain 18 and guide bar 20 extend. Housing 24 contains one or more gears (not shown) configured to cause rotation of chain 18 on guide bar 20 in response to rotation of drive shaft 38. Gear head 22 further includes an oil filler port 26 for admission of chain-lubricating oil into gear head 22. First end portion 30 of pole 14 is coupled to a pole coupler 28 included in gear head 22.

A protective guard 15 extends about chain saw 12, as shown, for example, in FIGS. 1-4. Illustratively, guard 15 extends about gear head 22 to protect gear head 22 from damage due to falling trees, branches, and other debris and from impact with ground surface 13.

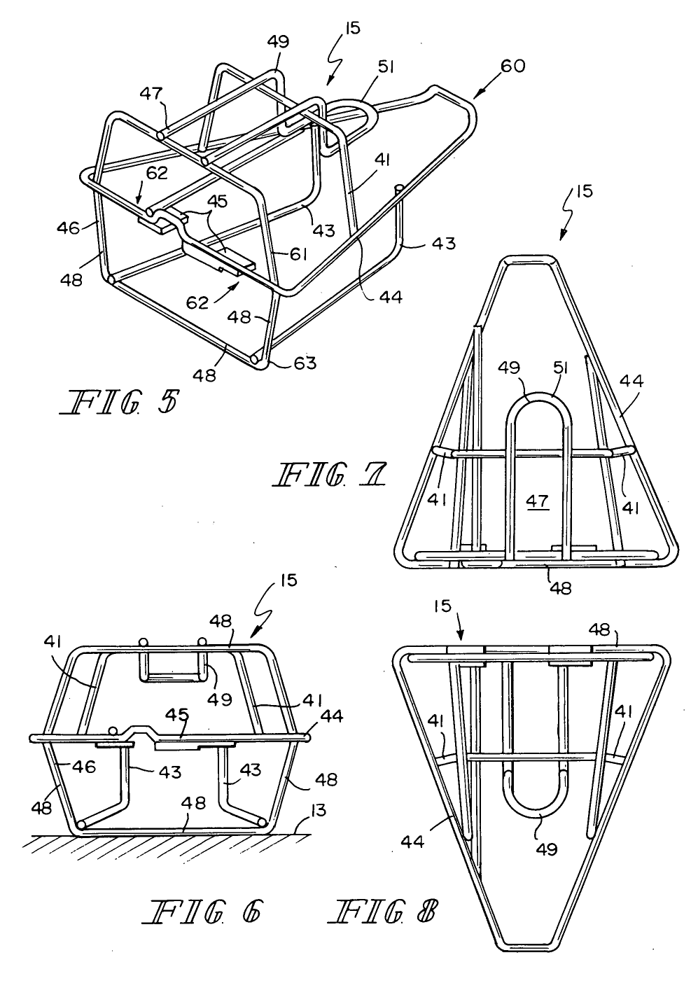

Guard 15 is configured, for example, as a cage including a plurality of connected rails, as shown, for example, in FIGS. 5-8. Guard 15 includes a trapezoid-shaped central rail 44, a pair of support plates 45, a hexagon-shaped front rail 48 formed to include an opening 46, a generally Z-shaped upper rail 49, an inverted U-shaped rail 41, and a pair of L-shaped bottom rails 43.

Trapezoid-shaped central rail 44 is arranged to receive pole 14 on a rear portion 60 of central rail 44. Support plates 45 are coupled to a front portion 62 of central rail 44 to support chain saw 12. Hexagon-shaped front rail 48 is formed to include opening 46 through which guide bar 20 extends and that extends lower than chain saw 12 for engagement with ground surface 13 to space chain saw 12 apart from ground surface 13. Front rail 48 thus provides guard 15 with a standoff 63 to facilitate keeping saw plane 17 in a selected orientation such as generally parallel to ground surface 13 to cut object 11 generally flush therewith during use of cutting apparatus 10.

Generally Z-shaped upper rail 49 includes a first end 47 coupled to front rail 48 and a second end 51 coupled to chain saw 12. Inverted U-shaped rail 41 is coupled to central rail 44 and supports upper rail 49. Each L-shaped bottom rail 43 is coupled to front rail 48 and central rail 44. Central rail 44, front rail 48, and upper rail 49 cooperate to provide an access aperture 61 to allow external access through aperture 61 to oil filler port 26 to add oil to gear head 22 without removal of guard 15 from gear head 22.

1. A cutting apparatus comprising
a chain saw that defines a saw plane and is adapted to cut vegetation along the saw plane,
a power source coupled to the chain saw to power the chain saw, and
means for carrying the chain saw and the power source in spaced-apart relation to one another to position the chain saw lower than the power source and adjacent to a ground surface to cut the vegetation, the carrying means including a pole coupled to and positioned between the chain saw and the power source and being curved along its length such that a longitudinal axis of the pole extends in non-parallel relation to the saw plane.

2. The cutting apparatus of claim 1, wherein the pole includes a first end portion, a second end portion, and a bend positioned between the first end portion and the second end portion, the chain saw is coupled to the first end portion, and the power source is coupled to the second end portion.

3. The cutting apparatus of claim 2, further comprising a handle and a shoulder harness, wherein the pole includes a longer portion and a shorter portion shorter than the longer portion, the bend is positioned between the longer portion and the shorter portion so that the longer and shorter portions are angled relative to one another, the shorter portion includes the first end portion to which the chain saw is coupled, the longer portion includes the second end portion to which the power source is coupled, and the handle and the shoulder harness are coupled to the longer portion.

4. The cutting apparatus of claim 3, further comprising means for maintaining separation between the chain saw and a person using the chain saw.

5. The cutting apparatus of claim 1, further comprising a head guard, wherein the chain saw includes a guide bar defining the saw plane, a chain coupled to the guide bar for movement about the guide bar, and a gear head and the head guard extends about the gear head.

6. The cutting apparatus of claim 5, wherein the head guard is configured as a cage.

7. The cutting apparatus of claim 5, wherein the head guard includes a standoff extending below the chain saw and adapted to engage the ground surface.

8. The cutting apparatus of claim 5, wherein the gear head includes an oil filler port and the head guard is formed to include an access aperture to allow external access through the access aperture to the oil filler port.

9. A cutting apparatus comprising
a chain saw that defines a saw plane and is adapted to cut an object along the saw plane, and
an elongated frame coupled to the chain saw to carry the chain saw, the elongated frame having a longitudinal axis extending in non-parallel relation to the saw plane.

10. The cutting apparatus of claim 9, wherein the elongated frame includes a pole that has the longitudinal axis and is coupled to the chain saw.

11. The cutting apparatus of claim 10, wherein the chain saw further includes a guide bar and a chain extending about a periphery of the guide bar and the guide bar defines the saw plane.

12. The cutting apparatus of claim 10, further comprising a power source arranged to operate the chain saw, wherein the pole includes a first end portion and a second end portion, the chain saw is coupled to the first end portion, the power source is coupled to the second end portion, and the pole is curved along its length between the first and second end portions.

13. The cutting apparatus of claim 12, further comprising a drive shaft extending through the pole and being curved along its length with the pole.

14. The cutting apparatus of claim 12, wherein the pole includes a longer portion and a shorter portion that is shorter than and angled relative to the longer portion, the shorter portion includes the first end portion to which the chain saw is coupled, and the longer portion includes the second end portion to which the power source is coupled.

15. The cutting apparatus of claim 10, wherein the pole is curved along its length.

16. The cutting apparatus of claim 9, further comprising a protective guard extending about the chain saw.

17. The cutting apparatus of claim 16, wherein the chain saw includes a gear head and the protective guard surrounds the gear head.

18. A cutting apparatus comprising
a chain saw including a guide bar and a chain coupled to the guide bar for movement about the guide bar, the guide bar defining a saw plane,
a power source,
a drive shaft connecting the power source and the chain saw, and
a pole through which the drive shaft extends, the pole including a first end portion and a second end portion, the chain saw being coupled to the first end portion, the power source being coupled to the second end portion, the pole being curved along its length as it extends from the first end portion to the second end portion such that a longitudinal axis of the pole extends in non-parallel relation to the saw plane.

19. The cutting apparatus of claim 18, further comprising a handle coupled to the pole.

20. The cutting apparatus of claim 18, further comprising a shoulder harness coupled to the pole.

21. The cutting apparatus of claim 18, further comprising a protective guard extending about the chain saw, wherein the protective guard includes a trapezoid-shaped central rail arranged to receive the pole on a rear portion of the central rail, a support plate coupled to a front portion of the central rail and supporting the chain saw, a hexagon-shaped front rail that is formed to include an opening through which the guide bar extends and that extends lower than the chain saw for engagement with a ground surface to space the chain saw apart from the ground surface, a generally Z-shaped upper rail including a first end coupled to the front rail and a second end coupled to the chain saw, an inverted U-shaped rail coupled to the central rail and supporting the upper rail, and a pair of L-shaped bottom rails coupled to the front rail and the central rail.
